(19) United States
(12) Patent Application Publication
(10) Pub. No.: US 2025/0104481 A1
(43) Pub. Date: Mar. 27, 2025

(54) METHOD AND SYSTEM OF IMAGE PROCESSING FOR DETERMINING LIVENESS OF A SUBJECT

(71) Applicant: HYPERVERGE INC., Irving, TX (US)

(72) Inventors: Vignesh Krishnakumar, Chennai (IN); Hariprasad P S, Chennai (IN); R V N S Kalyan, Hyderabad (IN); Karthik Pullalarevu, Bangalore (IN); Yogeeshwar S, Chromepet (IN)

(73) Assignee: HYPERVERGE INC., Irving, TX (US)

(21) Appl. No.: 18/891,650

(22) Filed: Sep. 20, 2024

Related U.S. Application Data
(60) Provisional application No. 63/584,825, filed on Sep. 22, 2023.

(51) Int. Cl. G06V 40/40; G06T 3/40; G06T 7/50; G06T 11/60; G06V 40/16

(52) U.S. Cl. CPC G06V 40/40; G06T 3/40; G06T 7/50; G06T 11/60; G06V 40/161

(57) ABSTRACT

The present invention relates to a method and system of image processing for determining liveness of a subject. The method comprises processing a captured image to create a plurality of target images. The method then encompasses generating a depth map corresponding to each target image from the plurality of target images. Further, the method comprises creating a plurality of modified images based on an addition of the depth map and a set of color models associated with the plurality of target images. Next, the method comprises detecting, by a plurality of multi-branch image liveness models, one of a presence of a set of non-live attacks and an absence of the set of non-live attacks in the plurality of modified images. Further the method leads to determining the liveness of the subject based on detection of the absence of the set of non-live attacks.

### CROSS REFERENCE TO RELATED APPLICATION

This application claims the benefit under 35 U.S.C. § 119(e) of U.S. Provisional Patent Application No. 63/584,825, filed Sep. 22, 2023, the entire contents of which are incorporated herein by reference.

### FIELD OF THE INVENTION

The present disclosure generally relates to biometric authentication-based liveness detection. More particularly, the present disclosure relates to a method and a system of image processing for determining liveness of a subject.

### BACKGROUND OF THE DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as an admission of prior art.

As the world becomes increasingly interconnected and reliant on digital platforms, the specter of identity fraud looms ever larger. Identity fraud poses a significant threat to individuals, businesses, and governments alike, leading to financial losses, compromised security, and reputational damage. Therefore, there is a pressing need for advanced measures to combat this growing menace. One essential solution lies in the development and implementation of robust liveness detection systems. These systems are designed to differentiate between real human beings and sophisticated impersonation attempts using artificial means like deepfakes, photoshop, digitally altered, synthetic images or other forged materials. By accurately verifying the genuine presence of a live person during identity verification processes, liveness detection ensures the authenticity and integrity of digital interactions, reinforcing trust, and safeguarding against fraudulent activities. As technology continues to evolve, the adoption of a resilient liveness detection system becomes paramount in fortifying the digital landscape against the ever-evolving tactics employed by identity fraudsters.

Over the period, face recognition technology has become an essential part of modern security systems. However, there is a growing concern over the vulnerability of such systems to spoofing attacks. Spoofing attacks refer to attempts by an impostor to impersonate a genuine user by presenting a fake or manipulated face image to the system. To counter such attacks, several anti-spoofing systems have been developed, falling under two categories: active and passive liveness solutions. Active liveness solutions require the subject to perform a pre-determined activity or any random motion. These solutions rely on the action performed by the subject to determine the liveness of the subject such as user. For example, an active liveness system may ask the subject to blink or nod their head. Passive liveness solutions, on the other hand, determine the liveness of the subject based on the input captured without expecting the subject to perform any sort of activity. Passive liveness systems are more desirable in real-world scenarios as they are easy to use and reduce user inconvenience.

Further, the known existing active liveness solutions require the subjects to carry out a complex and elaborate set of tasks, affecting the system's overall usability and making it difficult to be carried out for someone inexperienced with the procedure. Therefore, there is a need for more accessible and user-friendly passive liveness solutions. The most of the existing passive liveness solutions rely on depth information from stereovision cameras, infra-red readings from an IR sensor, photoplethysmography sensor, etc. Dependency on such sensors results in hardware constraints and would require a custom hardware setup for the system to be used. Such systems, therefore, cannot be implemented in a wide variety of day-to-day life electronic devices such as mobile phones, tablets etc. However, passive liveness systems relying on image information from cameras can be more accessible and easily consumed in the form of mobile or web applications. Further, few of the known approaches use only a specific portion of information from the captured image, such as corneal reflection, reflection from artificially induced illumination patterns, etc. This can cause such systems to be sensitive and less robust to the environment where the input is captured. Several external factors, such as the background of the subject illumination conditions, can affect the performance of the liveness detection system. Further, several existing approaches use a face detection module to crop out the face region from the input image and only use the specific face region to analyse the liveness. In the case of certain non-live attacks, such as presentation attacks on different display devices, print attacks, and mask-based attacks, apparent clues such as reflection, random text, borders, etc. will be lost if only the face region is used.

Therefore, there are a number of limitations to the existing solutions and in order to overcome these and such other limitations of the known solutions it is necessary to provide an efficient solution for image processing based liveness detection.

### SUMMARY

This section is provided to introduce certain aspects of the present disclosure in a simplified form that are further described below in the detailed description. This summary is not intended to identify the key features or the scope of the claimed subject matter.

An aspect of the present disclosure may relate to a method of determining liveness of a subject. The method initially comprises capturing, by a capturing unit, an image of the subject. Next, the method comprises processing, by a face detector unit, the image to create a plurality of target images. The method then encompasses generating, by a monocular depth estimation unit, a depth map corresponding to each target image from the plurality of target images. Further, the method comprises creating, by a creator unit, a plurality of modified images based on an addition of the depth map and a set of color models associated with the plurality of target images. Next, the method comprises providing, by an input unit, the plurality of modified images to a plurality of multi-branch image liveness models. The method thereafter comprises detecting, by the plurality of multi-branch image liveness models, one of a presence of a set of non-live attacks and an absence of the set of non-live attacks in the plurality of modified images. Further the method leads to determining, by a determination unit, the liveness of the subject based on detection of the absence of the set of non-live attacks in the plurality of modified images.

Another aspect of the present disclosure may relate to a system for image processing for determining liveness of a subject. The system comprises at least a capturing unit, a face detector unit, a monocular depth estimation unit, a creator unit, an input unit, a plurality of multi-branch image liveness models, and a determination unit. The capturing unit is configured to capture an image of the subject. Thereafter, the face detector unit is configured to process the image to create a plurality of target images. Further, the monocular depth estimation unit is configured to generate a depth map corresponding to each target image from the plurality of target images. The creator unit is then configured to create a plurality of modified images based on an addition of the depth map and a set of color models associated with the plurality of target images. The input unit is thereafter configured to provide the plurality of modified images to a plurality of multi-branch image liveness models. The plurality of multi-branch image liveness models are then configured to detect one of a presence of a set of non-live attacks and an absence of the set of non-live attacks in the plurality of modified images. Thereafter, the determination unit configured to determine the liveness of the subject based on detection of the absence of the set of non-live attacks in the plurality of modified images.

### OBJECTS OF THE DISCLOSURE

This section is provided to introduce certain non-limiting objects of the present invention.

In order to overcome at least a few problems associated with the known solutions as provided in the previous section, an object of the present disclosure is to substantially reduce the limitations and drawbacks of the prior known solutions as described hereinabove.

An object of the present disclosure is to provide a solution for image processing based liveness detection and to efficiently detect a fraudulent action.

Another object of the present disclosure is to provide a truly passive image processing based liveness detection system to efficiently detect a fraudulent action.

Another object of the present disclosure is to provide an image processing based passive liveness detection system that can be used on any device with a camera, such as mobile devices, computers, and edge devices, making it accessible and user-friendly for a broad range of users.

Yet another object of the present disclosure is to provide a solution that uses an image based data, to determine liveness, resulting in a more robust and accurate detection system.

Yet another object of the present disclosure is to provide a solution for an easy-to-integrate SDK for input capture for liveness detection that further allows the existing developers to integrate the solution into their existing applications.

Yet another object of the present disclosure is to provide a solution that is compatible with a mobile or web application, providing a user-friendly interface for end-users to interact with the liveness detection system.

### BRIEF DESCRIPTION OF DRAWINGS

The accompanying drawings, which are incorporated herein, constitute a part of this disclosure. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components. Although exemplary connections between sub-components have been shown in the accompanying drawings, it will be appreciated by those skilled in the art that other connections may also be possible, without departing from the scope of the invention. All sub-components within a component may be connected to each other, unless otherwise indicated.

FIG. 1 illustrates an exemplary system of image processing for determining liveness of a subject, in accordance with exemplary embodiments of the present invention.

FIG. 2 illustrates an exemplary method of image processing for determining liveness of a subject, in accordance with exemplary embodiments of the present invention.

The foregoing shall be more apparent from a more detailed description of the invention below.

### DETAILED DESCRIPTION OF THE DISCLOSURE

In the following description, for the purposes of explanation, various specific details are set forth in order to provide a thorough understanding of the embodiments of the present invention. It will be apparent, however, that embodiments of the present invention may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present invention are described below, as illustrated in various drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

It should be noted that the terms “mobile device”, “user equipment”, “user device”, “communication device”, “device”, “electronic device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

A “processor” or “processing unit” refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required to perform the functions as disclosed in the present disclosure.

The present disclosure provides a solution of image processing for determining liveness of a subject. The solution as disclosed in the present disclosure encompasses capturing an image of the subject. The subject may be a person whose identity is required to be verified in various use cases such as while applying any application for banking purpose, etc. Once the image of the person is captured, said image is processed to create a plurality of target images. The plurality of target images includes a first image, a second image and a third image. The first image comprises a face of the subject, the second image comprises the face and a first pre-defined percentage (e.g., 50 percent) of a background detected in the image, and the third image comprises the face and a second pre-defined percentage (e.g., 100 percent) of the background. Further, after creating the plurality of target images, a depth map corresponding to each target image is generated. Thereafter, a plurality of modified images are created based on an addition of the depth map and a set of color models associated with the plurality of target images. The set of color models comprises a Hue, Saturation, Value (HSV) color model, a Luminance, Chrominance (YCbCr) color model, and a Red, Green, Blue (RGB) color model. The plurality of modified images are then provided as an input to a plurality of multi-branch image liveness models. The plurality of multi-branch image liveness models thereafter detects one of a presence of a set of non-live attacks and an absence of the set of non-live attacks in the plurality of modified images. Further, the liveness of the subject is determined based on detection of the absence of the set of non-live attacks in the plurality of modified images.

Therefore, the present disclosure provides an efficient and effective solution of image processing for determining liveness of the subject. The present disclosure overcomes the problem(s) associated with the known solutions by providing a solution for image processing based liveness detection that efficiently detects a fraudulent action. Also, the present solution provides a truly passive image processing based liveness detection system to efficiently detect a fraudulent action. Additionally, the present solution provides an image processing based passive liveness detection system that can be used on any device with a camera, such as mobile devices, computers, and edge devices, making it accessible and user-friendly for a broad range of users. Furthermore, the present disclosure provides a solution that uses an image based data, to determine liveness, resulting in a more robust and accurate detection system. The solution as provided in the present disclosure provides an easy-to-integrate SDK for input capture for liveness detection that further allows the existing developers to integrate the solution into their existing applications. Moreover, the present disclosure provides a solution that is compatible with a mobile or web application, providing a user-friendly interface for end-users to interact with the liveness detection system. Therefore, the present disclosure provides a solution that is technically advanced than the existing solution for liveness detection of the subject.

The present disclosure is further explained in detail below with reference now to the diagrams.

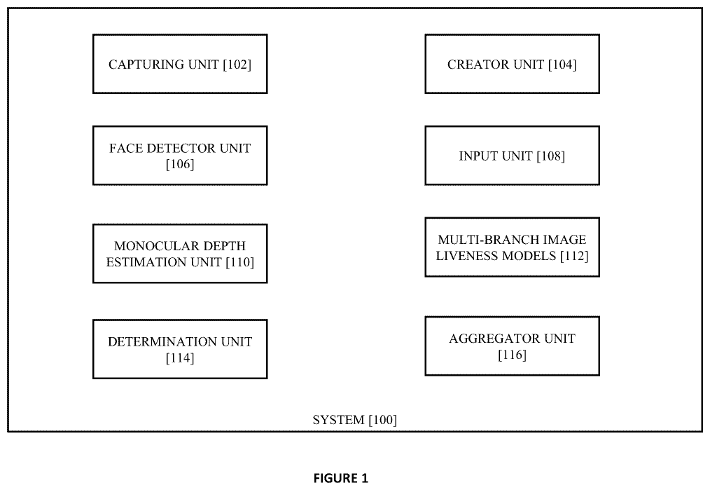

Referring now to FIG. 1, an exemplary system diagram [100] for image processing for determining liveness of a subject, in accordance with exemplary embodiments of the present invention is shown. The system encompasses at least one capturing unit [102], at least one creator unit [104], at least one face detector unit [106], and at least one input unit [108], at least one monocular depth estimation unit [110], at least one multi-branch image liveness models [112], at least one determination unit [114] and at least one aggregator unit [116]. All of these components/units of the system [100] are assumed to be connected to each other unless otherwise indicated below and working in conjunction to achieve the objectives of the present invention. While only a few exemplary units are shown in FIG. 1, it may be understood that the system [100] may comprise multiple such units or the system [100] may comprise any such number of the units performing said functionalities, obvious to a person skilled in the art or as required to implement the features of the present disclosure.

In an implementation, to perform the functions as disclosed in the present disclosure, the system [100] may be configured at a user device (e.g., a smartphone), or the system [100] may be in communication with the user device, or the system [100] may be in communication with a standalone device (such as a specialized device that may be obvious to a person skilled in the art to implement the features as disclosed in the present disclosure). Also, in another implementation the system [100] may be configured partially or as a whole at a server end, wherein one or more servers at the server end may be in communication with one or more user devices to implement the features of the present disclosure.

The system [100] is configured to process an image for determining liveness of a subject captured in the image, with the help of the interconnection between its components/units.

Initially to perform the image processing for determining liveness of the subject, the capturing unit [102] is configured to capture an image of the subject. The subject may be a person or a user whose identity is required to be verified in various use cases such as in an event where a user is required to capture his image for identity verification purposes. In an exemplary implementation of the solution as disclosed in the present disclosure, the capturing unit [102] is configured to capture one or more images of the subject from a user device or an electronic device such as a mobile phone, a computer, a tablet etc. connected to the system [100]. In such implementation a capture screen to a user of the user device or the electronic device is presented to capture an image of the user, wherein the capture screen includes a capture button and an area where a camera feed is displayed. Also, in a preferred implementation of the present solution, the captured camera feed is processed by the face detector unit [104] which may be a lightweight face detector to detect one or more faces in the camera feed. It would be appreciated by a person skilled in the art that the face detector unit [104] is not limited to the lightweight face detector, and another type of the face detector unit [104] may be considered depending on a use case. In another implementation of the present disclosure, the capture button is enabled only in a scenario where at least one face of an appropriate size is detected at the capture screen presented to the user. Further, in a scenario where at least one face of the appropriate size is detected, the capture button is enabled and a camera feed of the user is captured, wherein the camera feed of the user comprises capturing at least a frame associated with the image of the user. The frame associated with the image of the user hereinafter may also referred as a selfie image of the user.

Also, for capturing the image, at least one of a set of compliance checks and a set of sanity checks are performed. More specifically, in an exemplary implementation of the present solution, a compliance check such as an orientation check associated with the user device may be performed in order to ensure that it is held vertically with respect to the user before the capture button is enabled in order to facilitate capturing a camera feed via the user device. In an implementation of the present solution, the user may be presented with a preview screen to review the camera feed of the user. It is to be noted that the one or more sanity checks on at least a part of the camera feed of the user may be conducted in various ways, including but not limited to concurrent execution of at least the part of the camera feed by one or more units to facilitate image capturing, sequential execution of at least the part of the camera feed by a specialized unit to facilitate the image capturing, or any other method that may be apparent to a person skilled in the relevant field. The disclosure of the solution herein, which encompasses performing one or more sanity checks on at least a part of the camera feed of the user, should not be construed as imposing restrictions on the manner in which these sanity checks are performed. In an implementation in order to perform the one or more sanity checks on the camera feed of the user, a rotational invariant face detector is run via the face detector unit [104] through the selfie image of the user to identify one or more faces present in the selfie image. In an exemplary implementation of the present solution, the one or more sanity checks on the camera feed of the user may also encompasses identification of the one or more faces present in the selfie image based on coordinates that form a bounding box around the one or more faces in the selfie image, fiducial points of the one or more faces in the selfie image, wherein the fiducial points may be determined based on a location of a left eye associated with each face in the selfie image, a location of the right eye associated with each face in the selfie image, a location of the nose associated with each face in the selfie image, a location of the right corner of the lips associated with each face in the selfie image and a location of the left corner of lips associated with each face in the selfie image, and an angle of inclination of the one or more faces in the selfie image. Further, in an implementation if no face is identified, the user may be prompted to recapture the camera feed. Furthermore, in another implementation if multiple faces are detected in the selfie image, the user may be prompted to recapture the camera feed.

Further, in another exemplary implementation of the present solution, the one or more sanity checks on the camera feed of the user may also encompass performing a quality analysis for the selfie image which may be further performed via a neural network-based image quality assessment module, wherein the quality analysis of the selfie image is performed to detect at least one of an image blur issue, an image overexposure issue, an image underexposure issue, an image brightness issue and a lack of illumination issue in an image.

Further, in another exemplary implementation of the present solution, the one or more sanity checks on the camera feed of the user may also encompass performing a face posture check via a neural network to compute a face roll analysis, a face yaw analysis, and a face pitch analysis to understand the position of the face in the selfie image. Further, in another exemplary implementation of the present solution, an eyes region of the face in the selfie image is cropped out, to detect state of eyes of the face in the selfie image i.e., if the eyes are open or eyes are closed via a convolution neural network-based classifier. Furthermore, a presence of any obstruction such as eyeglasses or sunglasses on the face in the selfie image may also be detected via a convolution neural network-based object detector, and the presence of a face mask on the face in the selfie image is checked using the convolution network-based classifier.

Furthermore, in another implementation of the present solution, the one or more sanity checks on the camera feed of the user may also encompass one or more image manipulation checks performed via one or more convolution network-based models for the selfie image of the user to detect at least a face occlusion and an image manipulation. Further in an implementation of the present solution, to detect at least the face occlusion, the selfie image of the user may be passed through a convolutional network-based occlusion detection module, as the face of the user may be occluded e.g. with hands or other objects and hence the selfie image of the user in such scenario may not be optimal to determine the liveness of the user. Thus, the occlusion check ensures that the face of the user is visible and consistent in the selfie image of the user. Further, in an event the face is occluded, the input image/selfie image is rejected, and the user may be asked to retake the input image.

Furthermore, in another implementation of the present solution, the selfie image of the user may be checked based on the one or more image manipulation checks performed via one or more convolution network-based modules for an image manipulation, such as photoshop edits or deep fakes. The captured selfie image of the user may be passed through a convolution network-based deep fake classifier and image manipulation detectors in order to perform the one or more image manipulation checks, such as to detect any image manipulation(s) for e.g., a photoshop edit manipulation or a deep fake manipulation. Further, the one or more image manipulation checks may also be configured to successfully detect and reject synthetic images submitted through camera feed hijacking.

Thereafter, the face detector unit [104] is configured to process the image to create a plurality of target images. In an implementation the plurality of target images comprises at least a first image, a second image and a third image. The first image comprises a face of the subject, the second image comprises the face and a first pre-defined percentage of a background detected in the image, and the third image comprises the face and a second pre-defined percentage of the background. The first pre-defined percentage of a background in an implementation is 50 percent. The second pre-defined percentage of the background in an implementation is 100 percent. It would be appreciated by a person skilled in the art that each of the first pre-defined percentage of the background and the second pre-defined percentage of the background is not limited to 50 percent and 100 percent respectively, and its value may be considered depending on a use case.

More specifically, the face detector unit [104] to create the plurality of target images is configured with a neural network-based rotation-invariant face detector. The neural network-based rotation-invariant face detector detects one or more fiducial points on the face in the image along with a face bounding box. In an implementation, the neural network-based rotation-invariant face detector detects five fiducial points on the face corresponding to left eye, right eye, nose, left corner of the lips, and right corner of the lips along with a face bounding box. In an event if no face is detected in the captured image the user may be prompted to recapture the image. Also, in an event if more than one faces are detected in the captured image, a largest face from the detected faces is selected based on an area of bounding boxes. Furthermore, the face fiducial point(s) of the largest face detected in a captured image are used to align and crop the face in such a way that the line between the eyes is horizontal and the face is rescaled to a pre-defined fixed size. The face may be then wrapped such that the detected fiducial points fall as close as possible to predefined positions of the face crop. In another implementation the neural network-based rotation-invariant face detector detects and localizes face in the image, providing pixel coordinates that form a bounding box around the face. The first image, the second image and the third image are created from the original image using these face coordinates: the first image with only the face, the second image with the face and 50% background, and the third image with the face and 100% background.

Further, the monocular depth estimation unit [106] is configured to generate a depth map corresponding to each target image from the plurality of target images. As generally known, the depth map is an image or image channel that contains information relating to a distance of surfaces of scene objects from a viewpoint. Also, prior to generating the depth map the plurality of target images are resized in a pre-determined size. The pre-determined size may be a standard size of 224×224 pixels. It would be appreciated by a person skilled in the art that the pre-determined size is not limited to the 224×224 pixels, and its value may be considered depending on a use case.

Next, the creator unit [108] is configured to create a plurality of modified images based on an addition of the depth map and a set of color models associated with the plurality of target images. The set of color models comprises a Hue, Saturation, Value (HSV) color model, a Luminance, Chrominance (YCbCr) color model, and a Red, Green, Blue (RGB) color model. Additionally, HSV color model and YCbCr color model are computed from the RGB color model. Therefore, a final model input (i.e., the plurality of modified images) is created by adding the depth map, HSV and YCbCr images to the RGB image as a subsequent channel.

Also, each modified image from the plurality of modified images comprises a set of channels. In an implementation the plurality of modified images include three images and the set of channels of each modified image include 10 channels. It would be appreciated by a person skilled in the art that a number of channels in the set of channels is not limited to 10, and its value may be considered depending on a use case.

Further, the input unit [110] is configured to provide the plurality of modified images to a plurality of multi-branch image liveness models [112]. Also, each multi-branch image liveness model from the plurality of multi-branch image liveness models [112] receives the plurality of modified images in one of a simultaneous manner and one at a time manner. Moreover, each multi-branch image liveness model from the plurality of multi-branch image liveness models [112] is a neural network based model, and wherein said each multi-branch image liveness model is trained for detecting a specific type of non-live attack. The specific type of non-live attack is one of a display attack type, a print attack type, and a mask-based attack type. The display attack type is a type of digital attack (or referred herein as display attack) where a display configuration is tweaked with an intention of a display fraud. The print attack type is a type of digital attack (or referred herein as print attack) where a configuration of an image is tweaked with intention of a print related fraud. The mask attack type is a type of digital attack (or referred herein as mask attack) where a configuration of an image is masked with an intention of a masking related fraud. The said plurality of modified images (for instance as mentioned above the three images) are fed to the plurality of multi-branch image liveness models [112](e.g., three multi-branch image liveness models), which are capable of taking the plurality of modified images (e.g., the three images) as input simultaneously. The plurality of multi-branch image liveness models [112] are then configured to detect one of a presence of a set of non-live attacks and an absence of the set of non-live attacks in the plurality of modified images. The set of non-live attacks comprises at least one of one or more display attacks, one or more print attacks, and one or more mask-based attacks. In an implementation a first neural network from the plurality of multi-branch image liveness models [112] detects the one or more display attacks, a second neural network from the plurality of multi-branch image liveness models [112] detects the one or more print attacks, and a third neural network from the plurality of multi-branch image liveness models [112] detects one or more two dimensional (2D) mask attacks and one or more three dimensional (3D) mask attacks.

Thereafter, the determination unit [114] is configured to determine the liveness of the subject based on detection of the absence of the set of non-live attacks in the plurality of modified images. The determination of the liveness of the subject is further based on a detection of an absence of each non-live attack from the set of non-live attacks in each modified image from the plurality of modified images, by each corresponding multi-branch image liveness model from the plurality of multi-branch image liveness models.

Furthermore, each multi-branch image liveness model from the plurality of multi-branch image liveness models [112] is configured to generate an image liveness score based on one of the presence of the set of non-live attacks and the absence of the set of non-live attacks in the plurality of modified images. For instance, in an event where the absence of each non-live attack from the set of non-live attacks in each modified image from the plurality of modified images is detected, the image liveness score is generated as a high liveness score. The high liveness score validates the liveness on the subject. On the other hand, the presence of any non-live attack in any modified image from the plurality of modified images indicates a non-liveness of the subject. The more the presence of any non-live attacks, lower will be the image liveness scores and higher will be the chances of the non-liveness of the subject, which further indicates higher chances of a fraudulent action on the image.

Moreover, in an implementation, the aggregator unit [116] is configured to generate a final image liveness score based on a weighted combination of the image liveness score generated by said each multi-branch image liveness model. Also, the determination of the liveness of the subject is further based on a comparison of the final image liveness score with a pre-defined threshold score. In an implementation where the plurality of modified images include three images, an ensemble of the three multi-branch image liveness models determines a final output (i.e., the final image liveness score), with the image being considered live only when all three multi-branch image liveness models vote for it. Thereafter a final image liveness score is then given by combining a collective liveness score of the three multi-branch image liveness models. The final image liveness score is then compared with a pre-defined threshold score to determine the liveness of the subject. For instance, if the final image liveness score is greater than the pre-defined threshold score, then the liveness on the subject is validated. Otherwise, the liveness on the subject is not validated, which further indicates a fraudulent action on the image. A person skilled in the art would appreciate that the pre-defined threshold score may be configured on a use case basis and the condition of the final image liveness score to be greater than the pre-defined threshold score may also be modified on a use case basis and is non limiting.

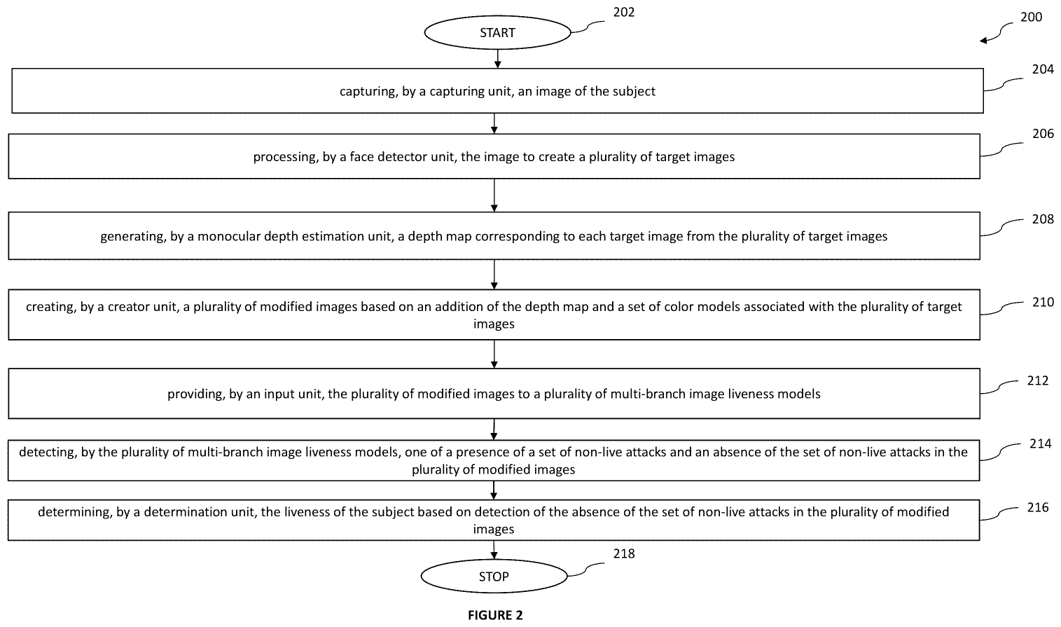

Referring to FIG. 2 that illustrates an exemplary method of image processing for determining liveness of a subject, in accordance with exemplary embodiments of the present invention. In an implementation, the method [200] is performed by the system [100]. As shown in FIG. 2, the method [200] begins at step [202]. In an implementation the method [200] may begin upon receiving a request for authentication or verification of a person via image processing.

In an event the method [200] may be implemented at a user device connected to the system [100], and an authentication or verification request may be received from an application such as a banking application, etc. at the system [100], to execute the method [200].

Next, at step [204], the method [200] comprises capturing, by the capturing unit [102], an image of the subject. The subject may be a person or a user whose identity is required to be verified in various use cases such as in an event where a user is required to capture his image for identity verification purposes. In an exemplary implementation of the solution as disclosed in the present disclosure, the capturing unit [102] is configured to capture one or more images of the subject from a user device or an electronic device such as a mobile phone, a computer, a tablet etc. connected to the system [100]. In such implementation a capture screen to a user of the user device or the electronic device is presented to capture an image of the user, wherein the capture screen includes a capture button and an area where a camera feed is displayed. Also, in a preferred implementation of the present solution, the captured camera feed is processed by the face detector unit [104] which may be a lightweight face detector to detect one or more faces in the camera feed. It would be appreciated by a person skilled in the art that the face detector unit [104] is not limited to the lightweight face detector, and another type of the face detector unit [104] may be considered depending on a use case. In another implementation of the present disclosure, the capture button is enabled only in a scenario where at least one face of an appropriate size is detected at the capture screen presented to the user. Further, in a scenario where at least one face of the appropriate size is detected, the capture button is enabled and a camera feed of the user is captured, wherein the camera feed of the user comprises capturing at least a frame associated with the image of the user. The frame associated with the image of the user hereinafter may also referred as a selfie image of the user.

Also, for capturing the image, at least one of a set of compliance checks and a set of sanity checks are performed. More specifically, in an exemplary implementation of the present solution, a compliance check such as an orientation check associated with the user device may be performed in order to ensure that it is held vertically with respect to the user before the capture button is enabled in order to facilitate capturing a camera feed via the user device. In an implementation of the present solution, the user may be presented with a preview screen to review the camera feed of the user. It is to be noted that the one or more sanity checks on at least a part of the camera feed of the user may be conducted in various ways, including but not limited to concurrent execution of at least the part of the camera feed by one or more units to facilitate image capturing, sequential execution of at least the part of the camera feed by a specialized unit to facilitate the image capturing, or any other method that may be apparent to a person skilled in the relevant field. In an implementation in order to perform the one or more sanity checks on the camera feed of the user, a rotational invariant face detector is run via the face detector unit [104] through the selfie image of the user to identify one or more faces present in the selfie image. In an exemplary implementation of the present solution, the one or more sanity checks on the camera feed of the user may also encompasses identification of the one or more faces present in the selfie image based on coordinates that form a bounding box around the one or more faces in the selfie image, fiducial points of the one or more faces in the selfie image, wherein the fiducial points may be determined based on a location of a left eye associated with each face in the selfie image, a location of the right eye associated with each face in the selfie image, a location of the nose associated with each face in the selfie image, a location of the right corner of the lips associated with each face in the selfie image and a location of the left corner of lips associated with each face in the selfie image, and an angle of inclination of the one or more faces in the selfie image. Further, in an implementation if no face is identified, the user may be prompted to recapture the camera feed. Furthermore, in another implementation if multiple faces are detected in the selfie image, the user may be prompted to recapture the camera feed.

Further, in another exemplary implementation of the present solution, the one or more sanity checks on the camera feed of the user may also encompass performing a quality analysis for the selfie image which may be further performed via a neural network-based image quality assessment module, wherein the quality analysis of the selfie image is performed to detect at least one of an image blur issue, an image overexposure issue, an image underexposure issue, an image brightness issue and a lack of illumination issue in an image.

Further, in another exemplary implementation of the present solution, the one or more sanity checks on the camera feed of the user may also encompass performing a face posture check via a neural network to compute a face roll analysis, a face yaw analysis, and a face pitch analysis to understand the position of the face in the selfie image. Further, in another exemplary implementation of the present solution, an eyes region of the face in the selfie image is cropped out, to detect state of eyes of the face in the selfie image i.e., if the eyes are open or eyes are closed via a convolution neural network-based classifier. Furthermore, a presence of any obstruction such as eyeglasses or sunglasses on the face in the selfie image may also be detected via a convolution neural network-based object detector, and the presence of a face mask on the face in the selfie image is checked using the convolution network-based classifier.

Furthermore, in another implementation of the present solution, the one or more sanity checks on the camera feed of the user may also encompass one or more image manipulation checks performed via one or more convolution network-based models for the selfie image of the user to detect at least a face occlusion and an image manipulation. Further in an implementation of the present solution, to detect at least the face occlusion, the selfie image of the user may be passed through a convolutional network-based occlusion detection module, as the face of the user may be occluded e.g. with hands or other objects and hence the selfie image of the user in such scenario may not be optimal to determine the liveness of the user. Thus, the occlusion check ensures that the face of the user is visible and consistent in the selfie image of the user. Further, in an event the face is occluded, the input image/selfie image is rejected, and the user may be asked to retake the input image.

Furthermore, in another implementation of the present solution, the selfie image of the user may be checked based on the one or more image manipulation checks performed via one or more convolution network-based modules for an image manipulation, such as photoshop edits or deep fakes. The captured selfie image of the user may be passed through a convolution network-based deep fake classifier and image manipulation detectors in order to perform the one or more image manipulation checks, such as to detect any image manipulation(s) for e.g., a photoshop edit manipulation or a deep fake manipulation. Further, the one or more image manipulation checks may also be configured to successfully detect and reject synthetic images submitted through camera feed hijacking.

Further, at step [206], the method [200] comprises processing, by the face detector unit [104], the image to create a plurality of target images. In an implementation, the plurality of target images comprises at least a first image, a second image and a third image. The first image comprises a face of the subject, the second image comprises the face and a first pre-defined percentage of a background detected in the image, and the third image comprises the face and a second pre-defined percentage of the background. The first pre-defined percentage of a background in an implementation is 50 percent. The second pre-defined percentage of the background in an implementation is 100 percent. It would be appreciated by a person skilled in the art that each of the first pre-defined percentage of the background and the second pre-defined percentage of the background is not limited to 50 percent and 100 percent respectively, and its value may be considered depending on a use case.

More specifically, the face detector unit [104] to create the plurality of target images works in conjunction with a neural network-based rotation-invariant face detector. The neural network-based rotation-invariant face detector detects one or more fiducial points on the face in the image along with a face bounding box. In an implementation, the neural network-based rotation-invariant face detector detects five fiducial points on the face corresponding to left eye, right eye, nose, left corner of the lips, and right corner of the lips along with a face bounding box. In an event if no face is detected in the captured image the user may be prompted to recapture the image. Also, in an event if more than one faces are detected in the captured image, a largest face from the detected faces is selected based on an area of bounding boxes. Furthermore, the face fiducial point(s) of the largest face detected in a captured image are used to align and crop the face in such a way that the line between the eyes is horizontal and the face is rescaled to a pre-defined fixed size. The face may be then wrapped such that the detected fiducial points fall as close as possible to predefined positions of the face crop. In another implementation the neural network-based rotation-invariant face detector detects and localizes face in the image, providing pixel coordinates that form a bounding box around the face. The first image, the second image and the third image are created from the original image using these face coordinates: the first image with only the face, the second image with the face and 50% background, and the third image with the face and 100% background.

Next, at step [208], the method [200] comprises generating, by the monocular depth estimation unit [106], a depth map corresponding to each target image from the plurality of target images. Also, prior to generating the depth map the plurality of target images are resized in a pre-determined size. The pre-determined size may be a standard size of 224×224 pixels. It would be appreciated by a person skilled in the art that the pre-determined size is not limited to the 224×224 pixels, and its value may be considered depending on a use case.

Thereafter, at step [210], the method [200] comprises creating, by the creator unit [108], a plurality of modified images based on an addition of the depth map and a set of color models associated with the plurality of target images. The set of color models comprises a Hue, Saturation, Value (HSV) color model, a Luminance, Chrominance (YCbCr) color model, and a Red, Green, Blue (RGB) color model. Additionally, the HSV color model and the YCbCr color model are computed from the RGB color model. Therefore, a final model input (i.e., the plurality of modified images) is created by adding the depth map, HSV and YCbCr images to the RGB image as a subsequent channel.

Also, each modified image from the plurality of modified images comprises a set of channels. In an implementation the plurality of modified images include three images and the set of channels of each modified image include 10 channels. It would be appreciated by a person skilled in the art that a number of channels in the set of channels is not limited to 10, and its value may be considered depending on a use case.

Further, at step [212], the method [200] comprises providing, by the input unit [110], the plurality of modified images to a plurality of multi-branch image liveness models [112]. Also, each multi-branch image liveness model from the plurality of multi-branch image liveness models [112] receives the plurality of modified images in one of a simultaneous manner and one at a time manner. Moreover, each multi-branch image liveness model from the plurality of multi-branch image liveness models [112] is a neural network based model, and wherein said each multi-branch image liveness model is trained for detecting a specific type of non-live attack. The specific type of non-live attack is one of a display attack type, a print attack type, and a mask-based attack type. The display attack type is a type of digital attack (or referred herein as display attack) where a display configuration is tweaked with an intention of a display fraud. The print attack type is a type of digital attack (or referred herein as print attack) where a configuration of an image is tweaked with intention of a print related fraud. The mask attack type is a type of digital attack (or referred herein as mask attack) where a configuration of an image is masked with an intention of a masking related fraud. The said plurality of modified images (for instance as mentioned above the three images) are fed to the plurality of multi-branch image liveness models [112](e.g., three multi-branch image liveness models), which are capable of taking the plurality of modified images (e.g., the three images) as input simultaneously.

Next, at step [214], the method [200] comprises detecting, by the plurality of multi-branch image liveness models [112], one of a presence of a set of non-live attacks and an absence of the set of non-live attacks in the plurality of modified images. The set of non-live attacks comprises at least one of one or more display attacks, one or more print attacks, and one or more mask-based attacks. In an implementation a first neural network from the plurality of multi-branch image liveness models [112] detects the one or more display attacks, a second neural network from the plurality of multi-branch image liveness models [112] detects the one or more print attacks, and a third neural network from the plurality of multi-branch image liveness models [112] detects one or more two dimensional (2D) mask attacks and/or one or more three dimensional (3D) mask attacks.

Then, at step [216], the method [200] comprises determining, by the determination unit [114], the liveness of the subject based on detection of the absence of the set of non-live attacks in the plurality of modified images. The determination of the liveness of the subject is further based on a detection of an absence of each non-live attack from the set of non-live attacks in each modified image from the plurality of modified images, by each corresponding multi-branch image liveness model from the plurality of multi-branch image liveness models.

Furthermore, the method comprises generating an image liveness score by each multi-branch image liveness model from the plurality of multi-branch image liveness models [112] based on one of the presence of the set of non-live attacks and the absence of the set of non-live attacks in the plurality of modified images. For instance, in an event where the absence of each non-live attack from the set of non-live attacks in each modified image from the plurality of modified images is detected, the image liveness score is generated as a high liveness score. The high liveness score validates the liveness on the subject. On the other hand, the presence of any non-live attack in any modified image from the plurality of modified images indicates a non-liveness of the subject. The more the presence of any non-live attacks, lower will be the image liveness scores and higher will be the chances of the non-liveness of the subject, which further indicates higher chances of a fraudulent action on the image.

Moreover, in an implementation, the method comprises generating by the aggregator unit [116] a final image liveness score based on a weighted combination of the image liveness score generated by said each multi-branch image liveness model. Also, the determining, by the determination unit [114], the liveness of the subject is further based on a comparison of the final image liveness score with a pre-defined threshold score. In an implementation where the plurality of modified images include three images, an ensemble of the three multi-branch image liveness models determines a final output (i.e., the final image liveness score), with the image being considered live only when all three multi-branch image liveness models vote for it. Thereafter a final image liveness score is then given by combining a collective liveness score of the three multi-branch image liveness models. The final image liveness score is then compared with a pre-defined threshold score to determine the liveness of the subject. For instance, if the final image liveness score is greater than the pre-defined threshold score, then the liveness on the subject is validated. Otherwise, the liveness on the subject is not validated, which further indicates a fraudulent action on the image. A person skilled in the art would appreciate that the pre-defined threshold score may be configured on a use case basis and the condition of the final image liveness score to be greater than the pre-defined threshold score may also be modified on a use case basis and is non limiting.

The method after determining the liveness of the subject then terminates at step [218].

Therefore, the present disclosure provides an efficient and effective solution of image processing for determining liveness of the subject. The present disclosure overcomes the problem(s) associated with the known solutions by providing a solution for image processing based liveness detection that efficiently detects a fraudulent action. Also, the present solution provides a truly passive image processing based liveness detection system to efficiently detect a fraudulent action.

Additionally, the present solution provides an image processing based passive liveness detection system that can be used on any device with a camera, such as mobile devices, computers, and edge devices, making it accessible and user-friendly for a broad range of users. Furthermore, the present disclosure provides a solution that uses an image based data, to determine liveness, resulting in a more robust and accurate detection system. The solution as provided in the present disclosure provides an easy-to-integrate SDK for input capture for liveness detection that further allows the existing developers to integrate the solution into their existing applications. Moreover, the present disclosure provides a solution that is compatible with a mobile or web application, providing a user-friendly interface for end-users to interact with the liveness detection system. Therefore, the present disclosure provides a solution that is technically advanced than the existing solution for liveness detection of the subject.

While the invention has been explained with respect to many examples, it will be appreciated by those skilled in the art that the invention is not restricted by these examples and many changes can be made to the embodiments disclosed herein without departing from the principles and scope of the present invention.

What is claimed is:

1. A method of image processing for determining liveness of a subject, the method comprising:
capturing, by a capturing unit, an image of the subject;
processing, by a face detector unit, the image to create a plurality of target images;
generating, by a monocular depth estimation unit, a depth map corresponding to each target image from the plurality of target images;
creating, by a creator unit, a plurality of modified images based on an addition of the depth map and a set of color models associated with the plurality of target images;
providing, by an input unit, the plurality of modified images to a plurality of multi-branch image liveness models;
detecting, by the plurality of multi-branch image liveness models, one of a presence of a set of non-live attacks and an absence of the set of non-live attacks in the plurality of modified images; and
determining, by a determination unit, the liveness of the subject based on detection of the absence of the set of non-live attacks in the plurality of modified images.

2. The method as claimed in claim 1, wherein for capturing the image the method comprises performing at least one of a set of compliance checks and a set of sanity checks.

3. The method as claimed in claim 1, wherein the plurality of target images comprises at least a first image, a second image and a third image.

4. The method as claimed in claim 3, wherein the first image comprises a face of the subject, the second image comprises the face and a first pre-defined percentage of a background detected in the image, and the third image comprises the face and a second pre-defined percentage of the background.

5. The method as claimed in claim 1, wherein prior to generating the depth map the method comprises resizing the plurality of target images in a pre-determined size.

6. The method as claimed in claim 1, wherein the set of color models comprises a Hue, Saturation, Value (HSV) color model, a Luminance, Chrominance (YCbCr) color model, and a Red, Green, Blue (RGB) color model.

7. The method as claimed in claim 1, wherein each modified image from the plurality of modified images comprises a set of channels.

8. The method as claimed in claim 1, wherein each multi-branch image liveness model from the plurality of multi-branch image liveness models receives the plurality of modified images in one of a simultaneous manner and one at a time manner.

9. The method as claimed in claim 1, wherein each multi-branch image liveness model from the plurality of multi-branch image liveness models is a neural network based model, and wherein said each multi-branch image liveness model is trained for detecting a specific type of non-live attack.

10. The method as claimed in claim 9, wherein the specific type of non-live attack is one of a display attack type, a print attack type, and a mask-based attack type.

11. The method as claimed in claim 1, wherein the set of non-live attacks comprises at least one of one or more display attacks, one or more print attacks, and one or more mask-based attacks.

12. The method as claimed in claim 1, wherein the determining, by the determination unit, the liveness of the subject is further based on a detection of an absence of each non-live attack from the set of non-live attacks in each modified image from the plurality of modified images, by each corresponding multi-branch image liveness model from the plurality of multi-branch image liveness models.

13. The method as claimed in claim 1, the method comprises generating an image liveness score by each multi-branch image liveness model from the plurality of multi-branch image liveness models based on one of the presence of the set of non-live attacks and the absence of the set of non-live attacks in the plurality of modified images.

14. The method as claimed in claim 13, the method comprises generating by an aggregator unit a final image liveness score based on a weighted combination of the image liveness score generated by said each multi-branch image liveness model.

15. The method as claimed in claim 14, wherein the determining, by the determination unit, the liveness of the subject is further based on a comparison of the final image liveness score with a pre-defined threshold score.

16. A system for image processing for determining liveness of a subject, the system comprising:
a capturing unit configured to capture an image of the subject;
a face detector unit configured to process the image to create a plurality of target images;
a monocular depth estimation unit configured to generate a depth map corresponding to each target image from the plurality of target images;
a creator unit configured to create a plurality of modified images based on an addition of the depth map and a set of color models associated with the plurality of target images;
an input unit configured to provide the plurality of modified images to a plurality of multi-branch image liveness models, wherein:
the plurality of multi-branch image liveness models are configured to detect one of a presence of a set of non-live attacks and an absence of the set of non-live attacks in the plurality of modified images; and
a determination unit configured to determine the liveness of the subject based on detection of the absence of the set of non-live attacks in the plurality of modified images.

17. The system as claimed in claim 16, wherein for capturing the image, at least one of a set of compliance checks and a set of sanity checks are performed.

18. The system as claimed in claim 16, wherein the plurality of target images comprises at least a first image, a second image and a third image.

19. The system as claimed in claim 18, wherein the first image comprises a face of the subject, the second image comprises the face and a first pre-defined percentage of a background detected in the image, and the third image comprises the face and a second pre-defined percentage of the background.

20. The system as claimed in claim 16, wherein prior to generating the depth map the plurality of target images are resized in a pre-determined size.

21. The system as claimed in claim 16, wherein the set of color models comprises a Hue, Saturation, Value (HSV) color model, a Luminance, Chrominance (YCbCr) color model, and a Red, Green, Blue (RGB) color model.

22. The system as claimed in claim 16, wherein each modified image from the plurality of modified images comprises a set of channels.

23. The system as claimed in claim 16, wherein each multi-branch image liveness model from the plurality of multi-branch image liveness models receives the plurality of modified images in one of a simultaneous manner and one at a time manner.

24. The system as claimed in claim 16, wherein each multi-branch image liveness model from the plurality of multi-branch image liveness models is a neural network based model, and wherein said each multi-branch image liveness model is trained for detecting a specific type of non-live attack.

25. The system as claimed in claim 24, wherein the specific type of non-live attack is one of a display attack type, a print attack type, and a mask-based attack type.

26. The system as claimed in claim 16, wherein the set of non-live attacks comprises at least one of one or more display attacks, one or more print attacks, and one or more mask-based attacks.

27. The system as claimed in claim 16, wherein the determination of the liveness of the subject is further based on a detection of an absence of each non-live attack from the set of non-live attacks in each modified image from the plurality of modified images, by each corresponding multi-branch image liveness model from the plurality of multi-branch image liveness models.

28. The system as claimed in claim 16, wherein each multi-branch image liveness model from the plurality of multi-branch image liveness models is configured to generate an image liveness score based on one of the presence of the set of non-live attacks and the absence of the set of non-live attacks in the plurality of modified images.

29. The system as claimed in claim 28, the system further comprises an aggregator unit configured to generate a final image liveness score based on a weighted combination of the image liveness score generated by said each multi-branch image liveness model.

30. The system as claimed in claim 29, wherein the determination of the liveness of the subject is further based on a comparison of the final image liveness score with a pre-defined threshold score.
